(19) United States
(12) Patent Application Publication
(10) Pub. No.: US 2025/0356247 A1
(43) Pub. Date: Nov. 20, 2025

(54) MODELLING DIFFUSION PROCESSES ROOTED IN REALITY

(71) Applicant: Dell Products L.P., Round Rock, TX (US)

(72) Inventors: Rômulo Teixeira de Abreu Pinho, Niterói (BR); Miguel Paredes Quiñones, Campinas (BR); João Victor Da Fonseca Pinto, Rio de Janeiro (BR); Micael Veríssimo de Araújo, Rio de Janeiro (BR)

(21) Appl. No.: 18/667,151

(22) Filed: May 17, 2024

(51) Int. Cl. G06N 20/00; G06N 5/04

(52) U.S. Cl. CPC G06N 20/00; G06N 5/04

(57) ABSTRACT

One example method includes collecting data associated with an evolutionary diffusion process, aggregating steps of the evolutionary diffusion process to define windows that each include a respective set of steps, using the steps in the windows to create a model that models changes between intermediate steps of the evolutionary diffusion process, and a final step of the evolutionary diffusion process, using the model to synthesize data samples associated with the intermediate steps, and using the synthesized data samples to train the model.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to the modeling of diffusion processes. More particularly, at least some embodiments relate to systems, hardware, software, computer-readable media, and methods, for modeling diffusion processes using real data, rather than using synthetically generated data and synthetic data degradation processes.

### BACKGROUND

Diffusion models (DM) are a class of generative AI (artificial intelligence) models that have been demonstrating good results in the realms of photorealistic synthetic image generation, and music composition, for example. DMs have also found successful applications in video and can be applied in general in time-series data generation.

To generate data, DMs start from a random pure-noise sample, such as a noisy image for example, and progressively remove the noise from the pure-noise sample until a clean image is generated. In addition, DMs can be guided to generate data associated with classes, such as a dog image for example, or even directly from natural language prompts such as, for example, “a dog with a birthday party hat.”

DMs may be trained by creating a synthetic dataset from real data where, programmatically, each data sample is smoothly deteriorated with noise over a pre-defined, and usually large, number T of steps. In an image dataset, for instance, each image x would thus have T noisy versions of itself. This is often referred to as a forward diffusion process. Further, DMs may revert this process by learning to iteratively remove noise one step at time, until a clean image is obtained at t=0. This is often referred to as a reverse diffusion process.

In standard implementations of DM (see reference [1] below), the noise added to the data is Gaussian, which makes the mathematical formulation easier and more efficient. However, others (see reference [2] below) have shown that the DMs can work with several types of smooth degradation functions, and also that some degradations are easier to be recoverable than others.

A notable problem with conventional DM versions, however, is that they rely on synthetic, and heavily controlled, data degradation processes. In particular, conventional DM approaches are not capable of modelling diffusion processes rooted in real data. Rather, such conventional approaches typically assume a rule of noise inclusion that is not necessarily present in, nor reflective of, a real life noising process.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings. Color versions of one or more of the Figures are incorporated herein in their entirety as an Appendix to this disclosure.

FIG. 1 discloses an example of progressive image deterioration with noise.

FIG. 2 discloses aspects of an example noise schedule.

FIG. 3 discloses an example of a quantum circuit acting on 5 qubits.

FIG. 4 discloses a geometrical interpretation of a quantum system.

FIG. 5 discloses an evolution of a probability distribution of an example quantum algorithm according to an embodiment.

FIG. 6 discloses an example of snapshots of an evolution of a probability distribution measured at the output of a quantum circuit at discrete time steps, according to an embodiment.

FIG. 7 discloses an example transition from raw evolutionary data to smooth scheduling steps, according to one embodiment.

FIG. 8 discloses the modeling of scheduled data patterns, according to one embodiment.

FIG. 9 discloses a method for training a DM with the data models and additional features, according to one embodiment.

FIG. 10 discloses an inference phase of a DM, according to one embodiment.

FIG. 11 discloses an approach for scheduling based on shot aggregation windows with fixed size, according to one embodiment.

FIG. 12 discloses an example of window scheduling strategies, according to one embodiment.

FIG. 13 discloses a comparison diffusion step aggregations with three scheduling methods across 40 windows, according to one embodiment.

FIG. 14 discloses an example of P(δᵢₜ|xᵢ₀, t) for one sample of a quantum state diffusion process, according to one embodiment.

FIG. 15 discloses an approach for estimating \hat{x}ᵢₜ=xᵢ₀+\hat{δ}ᵢₜ, ∀t with a model [symbol] (xᵢ₀, t)= [symbol] (μᵢₜ, σᵢₜ), according to one embodiment.

FIG. 16 discloses an approach for obtaining estimates for the probability distributions \hat{x}ₜ by sampling directly from x₀, according to one embodiment.

FIG. 17 discloses a training algorithm for a conventional DM.

FIG. 18 discloses a sampling algorithm for a conventional DM.

FIG. 19 discloses aspects of a method, according to one embodiment.

FIG. 20 discloses a computing entity configured and operable to perform any of the disclosed methods, processes, and operations.

### DETAILED DESCRIPTION OF SOME EXAMPLE EMBODIMENTS

Embodiments disclosed herein generally relate to the modeling of diffusion processes. More particularly, at least some embodiments relate to systems, hardware, software, computer-readable media, and methods, for modeling diffusion processes using real data, rather than using synthetically generated data and synthetic data degradation processes.

One example embodiment comprises a method for generating samples at different time steps of a natural diffusion process and learning to revert such process. While classic DM approaches synthesize such samples, an example method according to one embodiment may model the sample generation from the available, real, data. One example of such a method may comprise the following operations: collecting data related to steps of an evolutionary diffusion process; aggregating the steps of the evolutionary diffusion process to yield the smoothest possible evolutionary state transitions; modelling, from the aggregated evolutions, changes between intermediate steps and the final step of the evolution; employing the models to synthesize samples of intermediate steps; and using the synthesized samples to train and sample from the DM.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiments is that a diffusion process may be modeled based on real data, rather than based on synthetic data which may or may not produce an acceptable model of the diffusion process. An embodiment may, using real data, collect and aggregate steps of an evolutionary process, such as a diffusion process. An embodiment may revert a diffusion process observed in real data. Various other advantages of one or more example embodiments will be apparent from this disclosure.

### A. References

Reference may be made herein to various documents, which are listed below. These documents, all of which are incorporated herein in their respective entireties by this reference, may be referred to by their respective number [X] in the following listing.

[1] Yang, Ling, Zhilong Zhang, Yang Song, Shenda Hong, Runsheng Xu, Yue Zhao, Yingxia Shao,
Wentao Zhang, Bin Cui, and Ming-Hsuan Yang. “Diffusion Models: A Comprehensive Survey of
Methods and Applications.” arXiv, October 23, 2022. http://arxiv.org/abs/2209.00796.
[2] “Cold Diffusion: Inverting Arbitrary Image Transforms Without Noise,” n.d.
https://arxiv.org/abs/2208.09392.
[3] “Cosine similarity”, https://en.wikipedia.org/wiki/Cosine_similarity.
[4] “Fidelity of quantum states”, https://en.wikipedia.org/wiki/Fidelity_of_quantum_states.
[5]“Kullback-Leibler divergence”,
https://en.wikipedia.org/wiki/Kullback%E2%80%93Leibler_divergence.
[6] “Mean squared error”, https://en.wikipedia.org/wiki/Mean_squared_error.
[7] Joseph Rocca, “Understanding Diffusion Probabilistic Models (DPMs)”, December 5, 2022,
https://towardsdatascience.com/understanding-diffusion-probabilistic-models-dpms-
1940329d6048
[8] J. Sohl-Dickstein, E. Weiss, N. Maheswaranathan, and S. Ganguli, “Deep Unsupervised
Learning using Nonequilibrium Thermodynamics,” in Proceedings of the 32nd International
Conference on Machine Learning, PMLR, Jun. 2015, pp. 2256-2265. Accessed: Nov. 28, 2022.
[Online]. Available: https://proceedings.mlr.press/v37/sohl-dickstein15.html
[9] J. Ho, A. Jain, and P. Abbeel, “Denoising Diffusion Probabilistic Models,” in Advances in Neural
Information Processing Systems, Curran Associates, Inc., 2020, pp. 6840-6851. Accessed: Nov. 28,
2022. [Online].
Available: //proceedings.neurips.cc/paper/2020/hash/4c5bcfec8584af0d967f1ab10179ca4b-
Abstract.html

### B. Context for an Example Embodiment

### B.1 Diffusion Models

Diffusion Models (DM) are a class of generative AI models that have been demonstrating good results in the realm of photorealistic synthetic image generation. DMs have also found successful applications in video, audio, and time-series data generation. An in-depth review of DMs is set forth in [1].

DMs can be viewed as constituting a denoising operator. To generate data, DMs start from a random pure-noise sample, such as a noisy image for example, and progressively remove the noise until a clean image is obtained. In addition, DMs can be guided to generate data associated with classes, such as an image of a dog for example, or even directly from natural language prompts such as, for example, “a dog with a birthday party hat.”

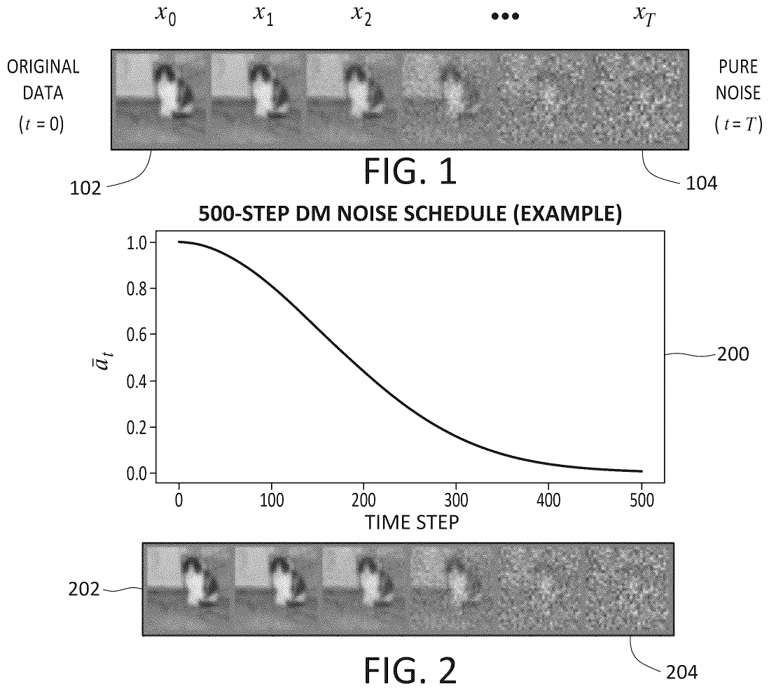

DMs are trained by creating a dataset from real data where, programmatically, each data sample is smoothly deteriorated with noise over a pre-defined (and usually large) number of T steps. In an image dataset, for instance, each image x would thus have T noisy versions of itself, as illustrated in FIG. 1. This is often referred to as a forward diffusion process. In particular, FIG. 1 discloses original data, at time X₀, the form of an image 102 of a cat, where the image 102 is progressively degraded over time until at a time X_{T}, the original data has become pure noise 104. A DM may revert this process by learning to iteratively remove noise, starting at time X_{T} in the example of FIG. 1, one step at time, until a clean image is obtained at t=0. This is often referred to as the reverse diffusion process.

In conventional implementations of DMs, the noise added to the data is Gaussian, which makes the mathematical formulation easier and more efficient. However, as noted in [2], DMs can work with several types of smooth degradation functions.

### B.1.1 DM Training and Sampling

One algorithm for training obtains random noisy samples at random steps, t (forward process), and refines the reconstruction of the noise (reverse process) by adjusting the model parameters, until convergence is achieved. A noise schedule determines how much noise ϵ(x₀, t) should be added to some data sample x₀ to form its noisy version xₜ for time step t:

$${x}_{0} = D ( {x}_{t} , t )$$

where D(⋅) is the denoise function.

For both DM training and inferencing, that is, sampling, the way the data is progressively deteriorated is a determining factor of how the model will learn the reverse process. This is referred to as a noise schedule. As mentioned above, conventional DM approaches apply increasing Gaussian noise as a function of the time step t. In practice, and thanks to some mathematical tricks, the noisy data version at step t can usually be obtained directly from the original data at t=0. This is done according to the following interpolation function

$${x}_{t} = \sqrt{\overline{{α}_{t}}} {x}_{0} + \sqrt{1 - {\overline{α}}_{t}} {ϵ}_{0} ,$$

where α̅ₜ represents the noise schedule and ϵ₀ is Gaussian noise [symbol] (0, l), as illustrated in the example noise schedule 200 of FIG. 2. In particular, FIG. 2 discloses an example T=500 time-step DM noise schedule used to generate noisy versions of the data, starting with the original data sample 202 at t=0, until the pure-noise version 204 is obtained at t=500.

At inference, or prediction, time, DMs implement what is referred to as sampling for data generation. One algorithm for sampling starts from pure noise at step T and infers the added noise ϵ(x, t) at each reverse time step, using the trained model. The estimated noise is then removed from the current sample, and the process repeats until a sample, such as an image without noise, is obtained at t=0.

### B.2 Quantum Circuits, Quantum Measurements, and Quantum Shots

For context, and as an illustration of one possible use case for an embodiment, some background is provided here on quantum states and probabilities and how they relate to a diffusion process that we can model with DMs. This example is only for the purposes of illustration however, and the scope of this disclosure extends more broadly to any type of diffusion process that, for example, can be modelled from real data that has similar behavior to a quantum circuit sampling.

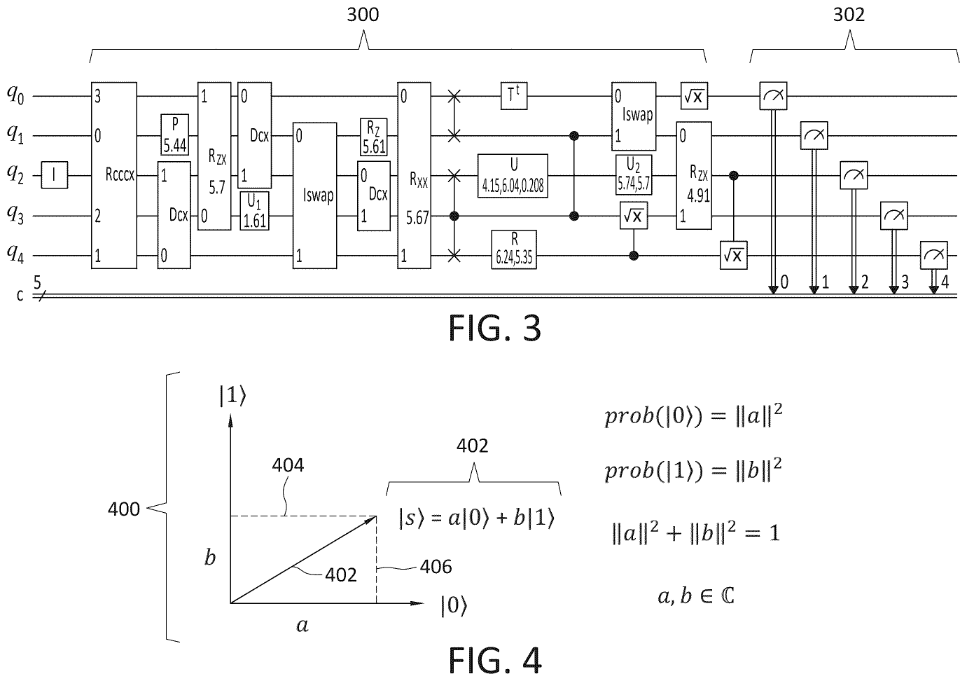

A quantum algorithm is the equivalent of a quantum circuit, as illustrated in FIG. 3, which discloses an example of a quantum circuit 300 acting on 5 (five) qubits collectively denoted at 302. The quantum algorithm contains a set of instructions, or gates, that manipulate quantum states. Quantum states correspond to some state of interaction between quantum bits, such as the qubits 302, which are the basic unit of information in quantum computing systems.

Qubits are the mathematical equivalent of vectors in a complex geometric space. In a quantum algorithm, qubits form a vectorial basis with 2ⁿ components, where n is the number of qubits used in the algorithm. Linear combinations of the components of form the basis for the referred quantum states.

A special instruction in quantum circuits is the measurement operation, which allows algorithm developers to obtain the results of the algorithm. The measurement is a projection of the final quantum state vector, at the end of the algorithm, onto one component of the basis. Further, a state is said to collapse onto one of the components of the vectorial basis.

Following the rules of quantum physics, a state collapse via a measurement operation is probabilistic, and the probability of a state collapsing onto one of the components of the basis is equal to the square of the magnitude of the, complex, amplitude of the state along that component, as illustrated in FIG. 4 for a single qubit. In particular, FIG. 4 discloses a geometrical interpretation 400 of a quantum system with one qubit forming a vectorial basis with two components (|0 [symbol] and |1 [symbol] ). The quantum state |s [symbol] 402 is a linear combination, or superposition, between the components 404 and 406 of the basis.

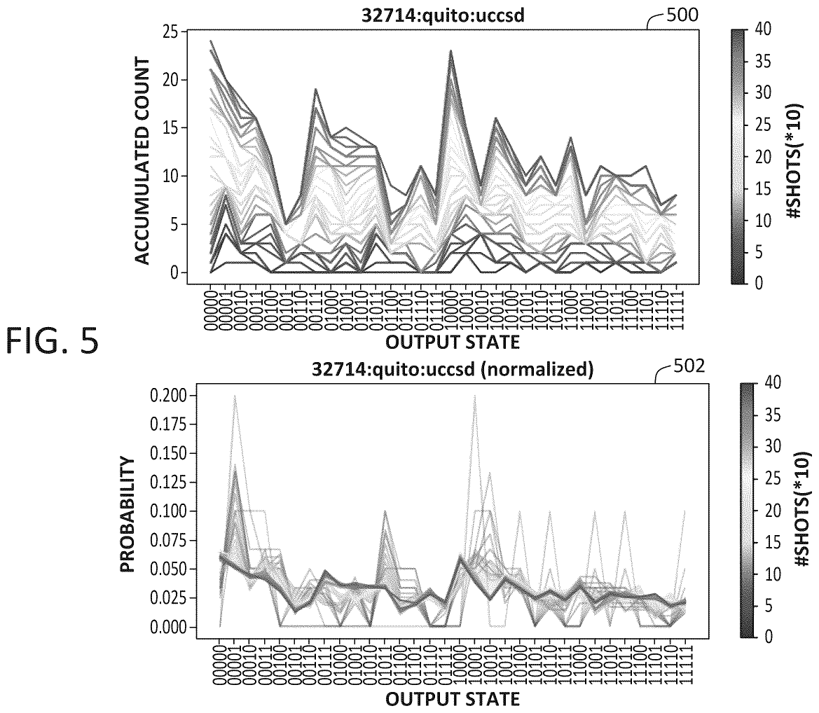

In practice, and following the rules of quantum physics, the state vector |s [symbol] can never be obtained directly. Each run of the quantum algorithm, also referred to as a ‘shot,’ collapses onto one of the basis states via a measurement operation. After several shots, an estimate may be obtained of the probability distribution that corresponds to the components of |s [symbol] . Namely, this probability distribution evolves towards a stable configuration, from which the components of |s [symbol] can be derived, as illustrated in FIG. 5. The probability distribution of the output states is typically obtained by counting the number of times |s [symbol] collapses onto each component of the basis, and then normalizing the counts to sum to 1.

In particular, FIG. 5 discloses an example evolution of the probability distribution of an example quantum algorithm from our dataset as the number of shots increases until 400 shots. The algorithm works on a quantum system with five qubits, meaning that the vectorial basis has 2⁵=32 components. The top view in FIG. 5 discloses a graph 500 of the accumulated count of the number of times each basis component was measured at the output. The bottom view in FIG. 5 discloses a graph 502 of the normalized counts forming a probability distribution. Note that the distribution evolves to a stable configuration as the shots are executed.

In more detail, each run of the algorithm is thus equivalent to sampling from the, unknown, state distribution and obtaining one element of the basis. In the limit, and according to the law of large numbers, sampling infinitely many times would reveal the expected distribution of components, but, in practice, an approximation of this distribution is sought after by running a finite, but still large, number of shots. A quantum algorithm developer may eventually determine a fixed number of shots in the hope that the obtained distribution is close to the one expected. As the circuit is repeatedly executed, it can thus be observed how the probability distribution reveals itself, from a coarse and unstable representation to a finer and more stable one, as shown in the graphs 500 and 502 of FIG. 5. An example embodiment may, in one example use case, employ the data that captures this evolution to predict the final output of a quantum circuit.

### C. Overview of Aspects of an Example Embodiment

### C.1 Introduction

Typical diffusion models (DM) rely on synthetic, and heavily controlled, data degradation processes. In most implementations of DM, such as the examples of [1], such data generation is based on the composition of Gaussian functions, which makes the mathematical formulation easier, more efficient, and more amenable to machine learning model training. In [2]. It was shown that the DMs can work with several types of synthetic smooth degradation functions. In image processing applications, such functions may consist of blurring, cropping, and snowification, for example.

By way of contrast, one or more example embodiments comprise a methodology to train and sample from DMs by leveraging data collected from real evolutionary processes, as in the quantum computing example referred to herein. In an embodiment, the methodology includes mechanisms to adjust the data to make it more amenable to machine learning model training. Put another way, an embodiment may comprise a method to learn how to revert diffusion processes that are rooted in reality. To achieve this, an embodiment may comprise training and sampling mechanisms that leverage patterns collected from real data. An example use case to which a diffusion model approach, according to one embodiment, is applied is that of quantum computing. More generally however, the disclosed methods generalize to any type of modelling of naturally occurring diffusion processes.

### C.2 Discussion

Quantum algorithms are inherently stochastic because of (1) the non-determinism of quantum systems, according to the laws of quantum physics, and (2) the noise present in the implementation of quantum hardware, which interferes with the computation. As a result, obtaining the result of a quantum algorithm requires executing it several times, also known as the number of shots.

The output of quantum circuits typically consists of the probability, or amplitude, of the expected quantum states obtained via measurement operations. Each measurement yields one quantum state, which is affected by both the configuration of the algorithm as well as by the noise present in the system. Each run of the algorithm, including a measurement operation, is thus equivalent to sampling from the, unknown, state distribution and obtaining one state. In the limit, and according to the law of large numbers, sampling infinitely many times would reveal the expected distribution of states.

Since running an algorithm infinitely many times is unfeasible, quantum algorithm developers determine a fixed number of shots in the hope that the obtained distribution is the one expected. Thus, there is an interest in predicting the final state distribution of a quantum circuit from some intermediary step, using a DM mechanism. One embodiment may assume the diffusion process in question corresponds to the evolution of quantum state distributions across the quantum shots, or any other evolutionary process for which data is available at each evolution step. An embodiment may thus model such diffusion process by collecting data from the execution of quantum shots across a variety of quantum circuits.

In effect then, an embodiment may comprise one or more processes of generating samples at different time steps of the “natural” diffusion process, and learning to revert such process. While conventional DM approaches synthesize such samples, typically in real time based on some know hand-crafted transformations, an embodiment may model the sample generation from the available data. In one example embodiment, a method may comprise the operations:
1. collecting data related to steps of some evolutionary, that is, diffusion, process;
2. aggregating steps of the evolution to yield the smoothest possible evolutionary state transitions;
3. modelling, from the aggregated evolutions, changes between intermediary steps and the final step of the evolution;
4. employing the models to synthesize samples of intermediary steps; and
5. using the synthesized samples to train and sample from the DM.

Thus, an example embodiment may possess various useful aspects. For example, an embodiment may comprise a set of approaches for collecting and aggregating steps of an evolutionary (diffusion) process. An embodiment may comprise a set of models to capture evolutionary state transitions from the collected data. Finally, an embodiment may comprise the application of the models to synthesize samples for training of and sampling from diffusion models.

### D. Detailed Discussion of Aspects of One, or More, Example Embodiments

One aspect of an embodiment concerns the connection between how probability distributions are obtained from quantum measurements and the diffusion processes of DMs. Indeed, as mentioned above, quantum state distributions typically evolve from an unstable configuration, at the initial shots, to a stable configuration at the end of the computation. By modelling this evolution, an embodiment may be able to estimate the final output of a circuit from just a few noisy shots.

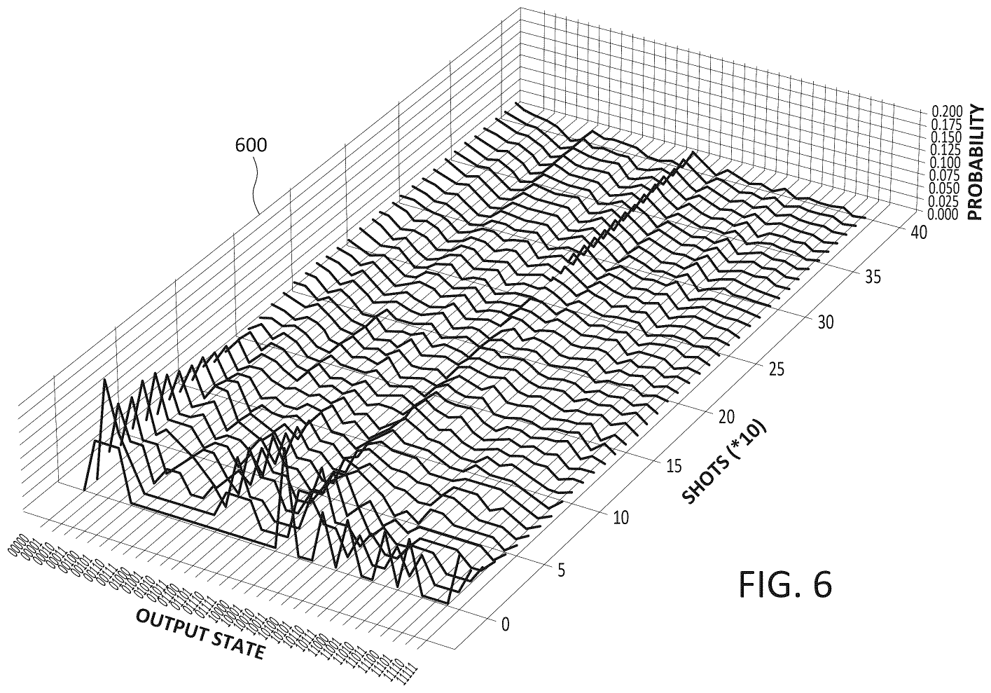

This is where the DM enters the process. Particularly, through the DM inferencing, and scheduling, mechanisms, an embodiment may provide, to the trained model, a snapshot of the evolution of the quantum state distribution at some intermediary step t and have the model evolve it until the final step, T. Eventually, at step T, an embodiment may obtain an estimate of the final output of the circuit. To achieve this, the DM may be trained with a dataset corresponding to N*[T+1] probability distributions obtained from a large number, N, of quantum circuits, where T is the number of time steps, or snapshots, collected during the executions, as illustrated in the example of FIG. 6. This is where a “rooted in reality” aspect of an embodiment comes from, and it is noted, again, that this could be applied to any naturally occurring diffusion or evolutionary process from which data could be collected. Particularly, FIG. 6 discloses a plot 600 of snapshots of the evolution of a probability distribution measured at the output of a quantum circuit at discrete time steps. Note that this is the same result as disclosed in FIG. 5, but laid out along the time dimension. As shown, the probability distribution is initially quite unstable, but has become quite stable after 400 shots.

Ultimately, one embodiment may rely on the definition of scheduling strategies that leverage the availability of real data about some diffusion process. In the example use case of quantum circuits, a schedule is built upon the data obtained through the execution of the quantum shots. Namely, at the last shot, when the probability distribution is assumed to be stable, it may be thought of as having the equivalent of a clean data sample at t=0, in DM terms.

If the circuit execution is played in revers, it can be thought of as having the equivalent of a degradation function that removes information from the probability distribution until the first shot, at t=T, in DM terms. It is noted that a “clean” data sample in the quantum realm may still be affected by system noise, one embodiment is focused on the diffusion, or evolutionary, process that leads from an unstable quantum state probability distribution to a stable quantum state probability distribution. For the purposes of this disclosure, “clean” and “stable” may be used interchangeably.

### D.1 General Architecture

As discussed in more detail below, all phases of the standard DM training and inference will be affected in some way by one example embodiment. In this section, an overview of the general architecture according to one embodiment is provided.

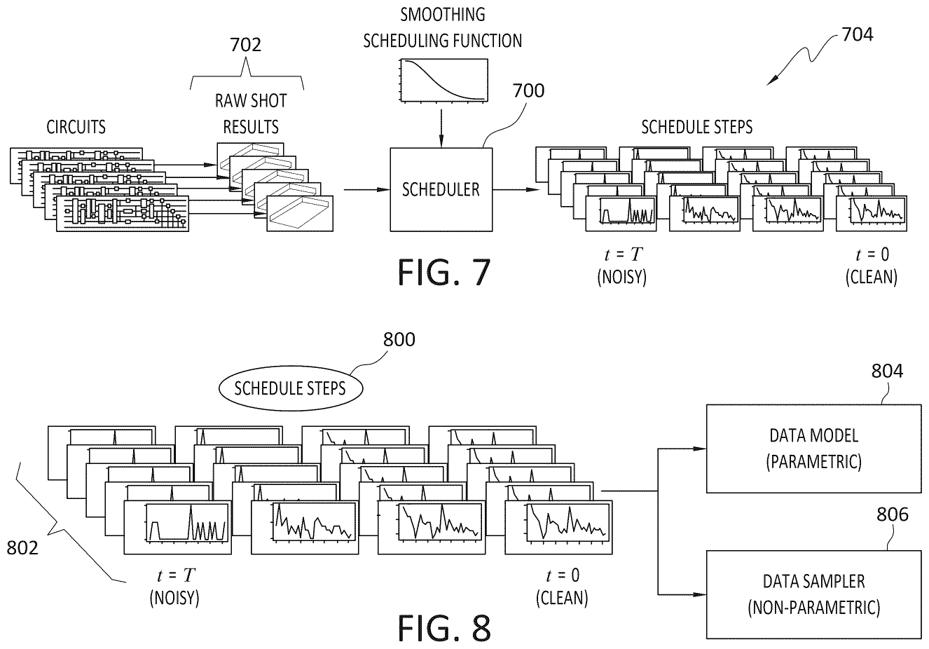

FIG. 7 discloses how, in one embodiment, the data collection and preparation take place with the use of a scheduler 700, particularly, FIG. 7 discloses a transition from raw evolutionary data, such as raw shot outcomes 702 for example, to smooth scheduling steps. That is, a purpose of the scheduler 700 is to convert the probability distributions derived from raw shot outcomes 702 into a representation, or schedule 704, of discrete time steps. The discrete time steps in the schedule 704 correspond to transitions from a clean representation of data at time t=T to a noisy representation of that data at time t=0. A constraint targeted for satisfaction in this process is that the transitions between time steps are as smooth as possible, while retaining the least possible amount of data.

After obtaining the smooth scheduled data, an embodiment may comprise learning data patterns that may eliminate the need to store all of such data for training. As explained earlier herein, a conventional DM approach defines data degradation functions that synthesize noisy samples at arbitrary time steps. One example embodiment may take a similar approach but with the modification, relative to conventional approaches, that degradation functions are directly derived from the scheduled, real, data. FIG. 8, directed to modelling scheduled data patterns, discloses how, in one or more embodiments, the scheduled data may serve as input for two different modelling approaches. That is, over a group of schedule steps 800, data 802 may transition from a noisy state at time tr, to a clean state at time to. The clean data may be provided as input to various modelling approaches such as, for example, a parametric data model 804, and/or a non-parametric data sampler 806.

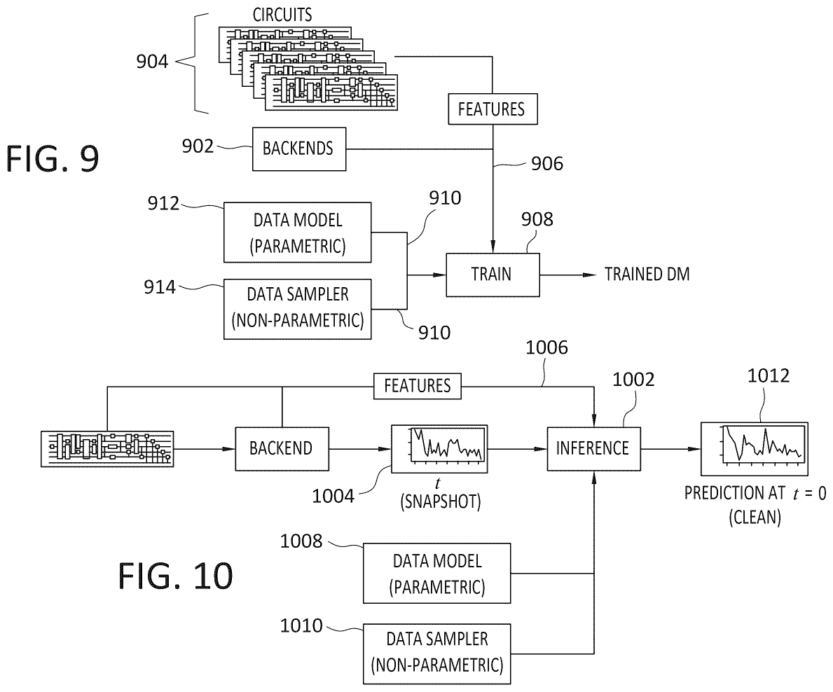

These models and/or other models may then be used to train the DM itself. As shown in FIG. 9, data coming from backends 902 and circuits 904 are transformed into features 906 and fed to DM 908 during training, along with synthetic data 910 provided by the scheduled data models. As will be clear later on, the training process probes any of the data models 912 and 914 to yield noisy data samples at arbitrary time steps. From such samples, the DM learns to remove the synthetic degradations and obtain an estimate of the clean data at t=0.

After it has been trained, the DM may be used at inference time to obtain estimates of the clean data at step t=0. This is shown in FIG. 10 which discloses an inference phase 1002 of the DM. The training model that performs the inference phase 1002 receives a snapshot 1004 of an evolutionary process at some step t, along with additional features 1006, and employs the scheduled data models 1008 and 1010 to obtain estimates, that is, predictions 1012, of the clean data, that is, the final step of the evolution, at t=0.

As shown in the example of FIG. 10, the inference depends on the scheduled data models 1008 and 1010, and the additional features 1006. Given a quantum circuit and a backend to run it, the inferencing process performed in the inferencing phase 1002 initially receives a snapshot 1004 of the execution of the circuit at some arbitrary step. Knowing this step is potentially noisy, the inferencing process triggers the denoising mechanism that the DM learned during training. This may include probing the data models 1008 and 1010 to yield subsequent noisy data samples t−1, t−2, etc., until the clean data sample is obtained at t=0.

### D.2 Schedulers

Playing shots backwards, as suggested earlier herein, tends to generate non-smooth transitions of the probability distributions between steps, especially near the starting shots where the distributions as far less stable. To address this, an embodiment may employ a various different scheduling approaches to try to mimic the original DM behavior as much as possible. In particular, an embodiment may create and employ a scheduling approach that yields smooth probability transitions between steps.

One scheduling approach according to an embodiment is based on aggregating the raw evolutionary steps of the diffusion process, such as measurements of quantum shots, in one illustrative use case, into windows. One reason for this approach is that inter-window distribution transitions tend to be smoother than transitions shot-by-shot. In quantum computing, this is especially true during the initial shots. A challenge, however, is how to pick the right window size.

In this example use case, it would be ideal to predict the final quantum state distribution, or some other clean data, from just a few shots. On the one hand, aggregating shots into small windows may facilitate achievement of that objective, but the transitions between windows may still be rough. On the other hand, large windows make transitions substantially smoother, but this may potentially lead to too few windows to learn patterns from and too many shots may be required before a prediction can be made as to the final state configuration. Below, some example windowing strategies, according to one or more embodiments, are proposed that aim to balance the two objectives, that is, [1] smooth transitions versus [2] as few initial shots as possible. It should be noted that the correct choice will depend on the target application and on the data itself and, as such, the correct choice may depend upon the specific circumstances.

### D.2.1 Constant Window Schedules

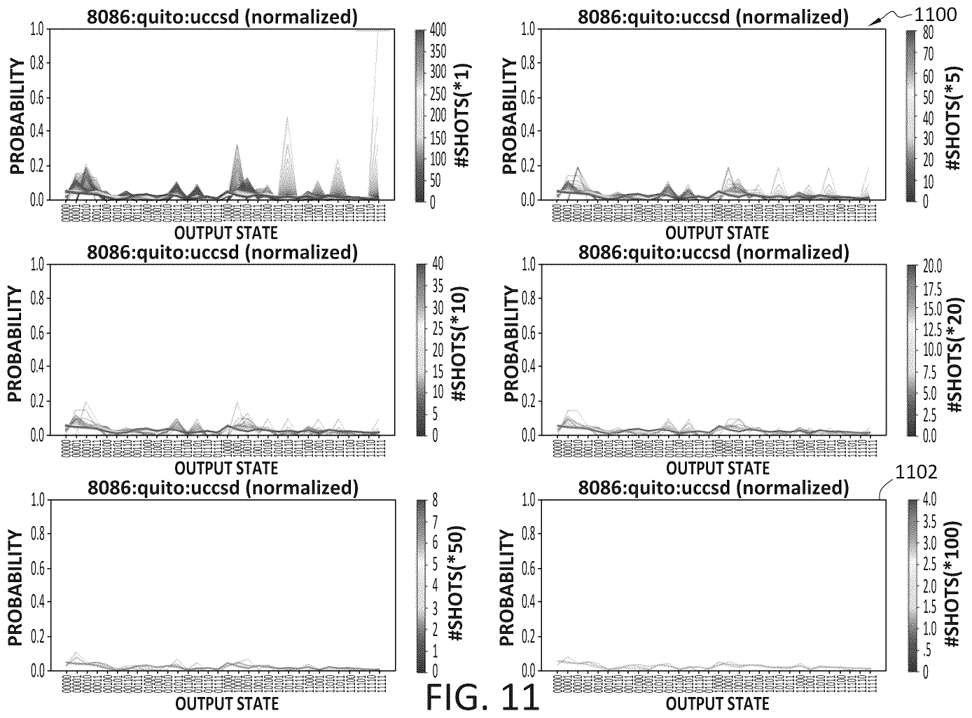

In this example scheduling approach, and with reference to the illustrative quantum circuit use case, the shots are aggregated into windows of fixed size. As discussed previously, there is a trade-off between transition smoothness and number of shots per window. In FIG. 11, the various graphs, collectively denoted at 1100, indicate, for a given quantum circuit executed with 400 shots, how the probability distributions evolve over time for different window sizes going from 1 to 100.

More particularly, FIG. 11 discloses scheduling based on shot aggregation windows with fixed size. Proceeding, in FIG. 11, from left, right, top, bottom, window sizes are 1, 5, 10, 20, 50, and 100, shots per window, respectively. Transitions between windows become clearly smoother with larger window sizes, at the cost of having too many shots per window and very few windows to train the DM. These samples were obtained based on quito IBM fake hardware and a unitary coupled cluster (UCCSD) circuit. The last configuration 1102, with 100 shots per window, is very smooth, but there are just 4 windows, which is too little to learn degradation patterns for the DM. In addition, it would require the circuit to be run for at least 100 shots before applying the trained DM.

### D.2.2 Window Decay Schedules

An alternative approach to the use of a constant window size is to employ a variable scheduling that tries to force smoothing of distribution transitions across the initial shots. Namely, an embodiment may aggregate more shots in the first windows and slowly decrease the number of shots per window until the end. By doing this, it is possible to find a better balance between [1] the total number of windows and [2] the minimum number of initial shots required.

Two example embodiments employ, respectively, a linear window size decay function, and an exponential window size decay function. Such window decay functions may comprise the parameters (1) a minimum window size, and (2) a point from which all windows will be fixed with that minimum window size.

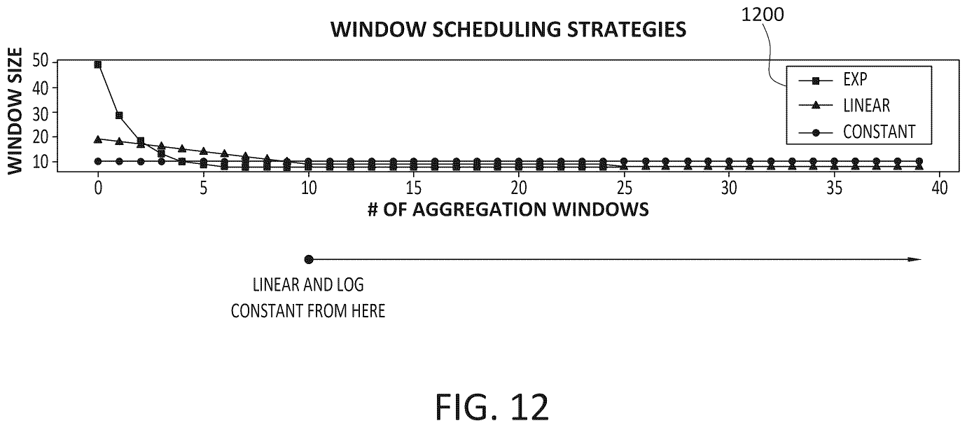

Then, from the first window to the point defined in (2), window sizes will either decrease linearly or exponentially, depending on the selected window size decay function. For the exponential function, the base of the decay may be defined. For the linear function, the slope of the decay may be defined. Any remaining steps may be cyclically added across all windows one by one. FIG. 12 illustrates three example window decay functions 1200.

In the illustrative example of FIG. 12, various different window scheduling strategies are applied to 40 windows aggregating 400 shots. The constant schedule assigns a fixed number of shots to each window, 10 shots per window in the example of FIG. 12. The linear and exponential schedules in this example set at least 8 shots per window starting from window 10. The initial window sizes decay either linearly or exponentially, depending on the chosen decay function.

### D.2.3 Choosing the Best Scheduler

As noted herein, the scheduling approaches aim to yield smooth transitions between steps of the diffusion process. To measure this, one embodiment may use some function that measures the differences between subsequent windows after the aggregation with a chosen schedule. Such differences can be converted into an evaluation metric such as the average inter-window distance across some dataset. In the case of quantum state distributions, one such difference function can be the cosine distance (discussed in [3]), given the duality between the probabilistic and the geometric interpretation of quantum states. Other distance metrics include the fidelity (discussed in [4], and also applicable in the case of quantum states), the KL-divergence (discussed in [5], and also applicable in the case of distributions), and the mean squared error (discussed in [6]), for example.

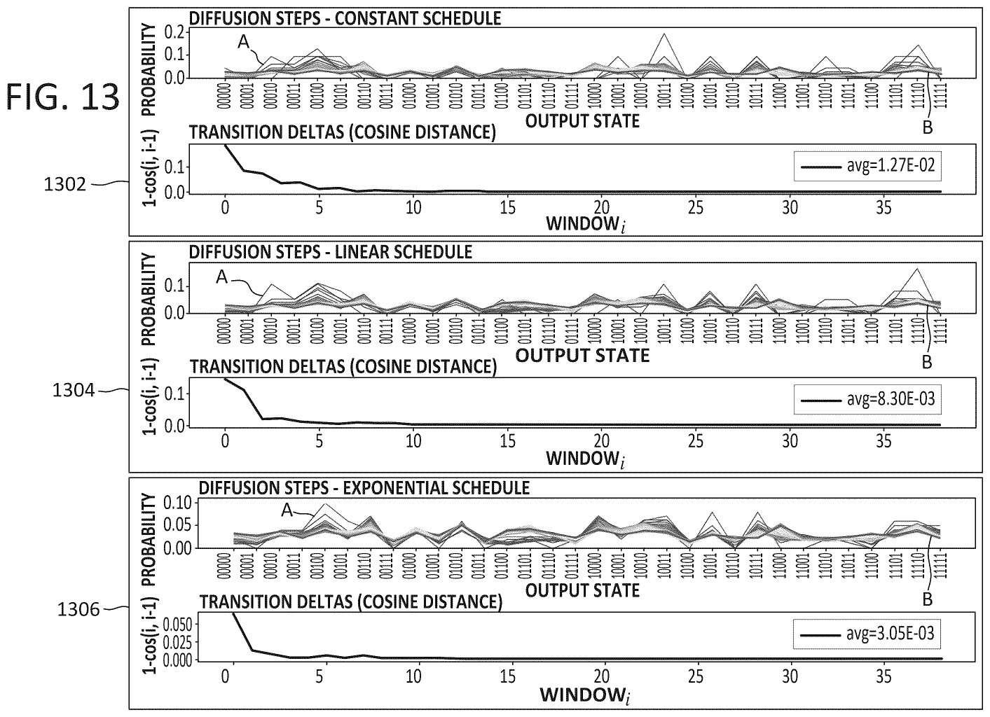

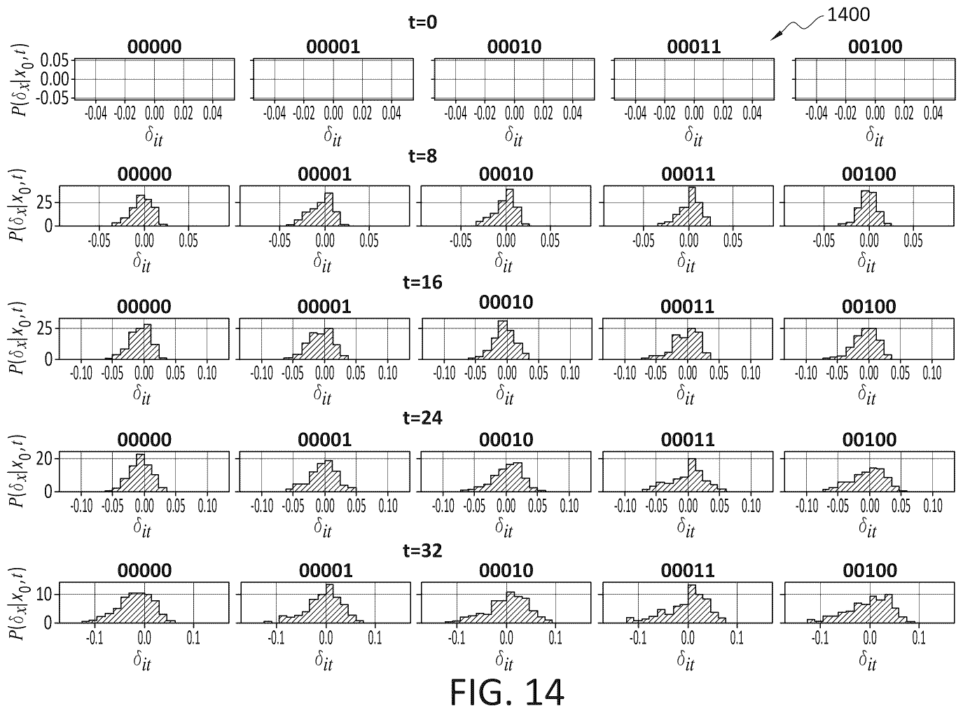

The example of FIG. 13 discloses a comparison with the evolutions of quantum states for a given quantum algorithm across 40 aggregation windows aggregating 400 steps, using the same parameters as disclosed in FIG. 12. Particularly, FIG. 13 discloses a comparison of diffusion step aggregations with three different scheduling methods across 40 windows. In this example, it can be seen that the exponential schedule yielded smoother transitions, that is, lower average cosine distance between subsequent windows, than the other two schedules.

In FIG. 13, each subfigure 1302, 1304, and 1306, shows the steps of the evolution (top), going from ‘A’ to ‘B’ over time, and the cosine distance between subsequent windows (bottom). The top subfigure 1302 shows the constant window size schedule, the middle subfigure 1304 shows the linear window size decay schedule, and the bottom subfigure 1306 shows the exponential window size decay schedule. As indicated in FIG. 13, the exponential window size decay yielded the lowest average cosine distance between subsequent windows. FIG. 13 also indicates the effect of the linear and exponential window size decay schedules on reducing the transition deltas at the early stages of the evolution, as intended.

In the example configuration disclosed in FIG. 13, the first window of the exponential window size decay schedule has 49 steps, that is, approximately 12% of the complete evolution of 400 steps, or shots in the quantum circuit use case. This means that, at inference time, a user would need to run approximately 12% of the intended evolution before being able to obtain good predictions with the DM. Analyzing the trade-offs between the smoothness of the transitions and the number of evolutions required at the initial steps of the chosen schedule is problem-dependent. Such an analysis may be performed in an automated fashion using any hyperparameter search technique, one example of which is derivative free.

### D.3 Modelling Diffusion Processes

Use of any of the window scheduling approaches discussed above may tend to reduce the size of the data through the aggregations of the diffusion steps. Nonetheless, all aggregations would still need to be kept across the entire dataset when training the DM. This may be an undesired side effect if the memory or storage capacity consumed/available for training is a concern. Conventional DM implementations address this issue by allowing a degraded sample xₜ to be directly obtained from the input data x₀, on demand, using some pre-defined function ϵ(x₀, t).

By way of contrast with such a conventional approach, an embodiment may, instead of using pre-defined functions, model ϵ(x₀, t) directly from the data and combine it with window scheduling approaches to synthesize samples xₜ on demand. Below, a discussion is presented of three different example mechanisms to model ϵ(x₀, t) based on the data and on the window schedules.

### D.3.1 Data Model (Parametric)

Consider a case where diffusion process data has been collected for N data samples, meaning that, for each data sample xᵢ, i∈{1, . . . , N}, one of the disclosed window scheduling functions has already been applied with T steps. The scheduling yields a sequence {xᵢ₀, xᵢ₁, . . . , x_{iT}}, where xᵢ₀ is the final, or clean, step of the diffusion process and x_{iT} is the initial, or noisiest, step of the diffusion process. This results in a dataset [symbol] with N*(T+1) samples in total.

Suppose further that xᵢⱼ∈ [symbol] , ∀i∈{1, . . . , N} and some operator fᵢₜ(xᵢ₀, xᵢₜ)∈ [symbol] is defined as the element-wise difference between step 0 and some step t of the diffusion process of xᵢ according to the applied window schedule. Computing δᵢₜ=fᵢₜ(xᵢ₀, xᵢₜ) across [symbol] yields another dataset [symbol] with the same size. A model [symbol] , with parameters θ, may be fit to [symbol] such that an estimate \hat{x}ᵢₜ= [symbol] (x₀, t) can be obtained for any arbitrary time step t.

One approach is to make [symbol] a probability distribution P(fₜ|x₀, t) and fit it onto the data set [symbol] , from which some \hat{δ}ᵢₜ˜P(fₜ|xᵢ₀, t) can be sampled. Then, an embodiment may synthesize \hat{x}ᵢₜ=fᵢₜ⁻¹ (xᵢ₀, \hat{δ}ᵢₜ). For instance, if δᵢₜ=xᵢₜ−xᵢ₀, then \hat{x}ᵢₜ=xᵢ₀+\hat{δ}ᵢₜ, where fₜ(⋅) is subtraction and fₜ⁻¹(⋅) is addition.

With reference to the example of FIG. 14, such probabilities are illustrated for one sample of a quantum state diffusion process with T=40 steps. That is, FIG. 14 discloses an example of P(δᵢₜ|xᵢ₀, t) for one sample 1400 of a quantum state diffusion process with T=40 steps, where δᵢₜ=fᵢₜ(xᵢ₀, xᵢₜ)=xᵢₜ−xᵢ₀, for a handful of values of t, namely, 0, 8, 16, 24, and 32. In this example, P(δᵢₜ|xᵢ₀, t) may be characterized as roughly Gaussian in most cases. For the sake of simplicity, FIG. 14 only shows d=5 dimensions (i.e., xᵢⱼ∈ [symbol] ) as the columns of the figure. The rows of FIG. 14 exemplify P(δᵢₜ|xᵢ₀, t) across the dimensions of xᵢⱼ, where δᵢₜ=fᵢₜ(xᵢ₀, xᵢₜ)=xᵢₜ−xᵢ₀, for a handful of values of t. As expected, the ranges of δᵢₜ tend to increase as t gets further from T.

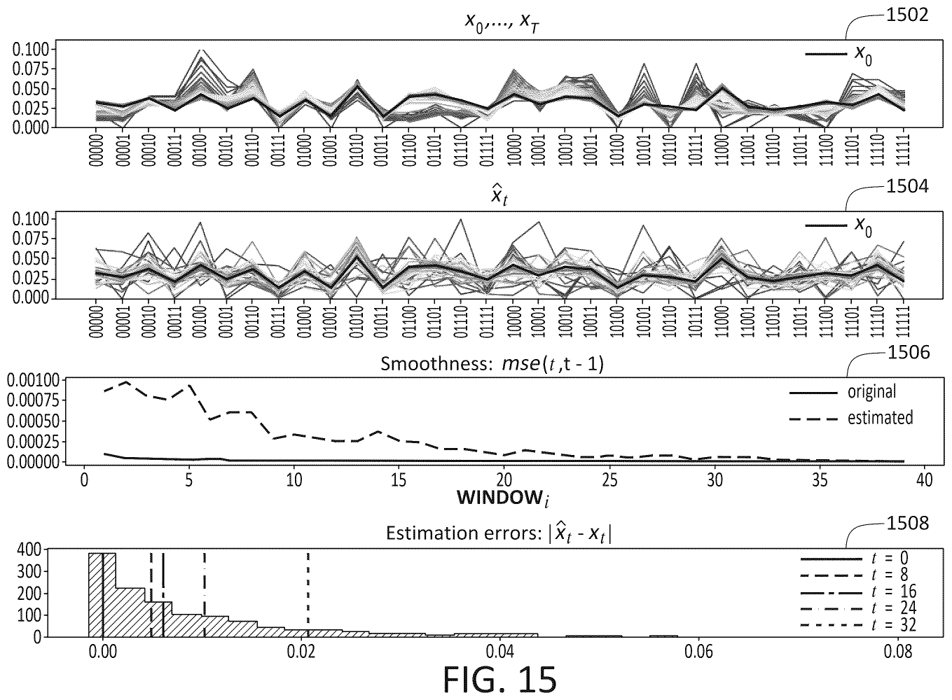

By assuming that P(δᵢₜ|xᵢ₀, t) is approximately Gaussian in the example of FIG. 14, the relation [symbol] (xᵢ₀, t)= [symbol] (μᵢₜ, σᵢₜ) can be established, and then used to sample \hat{δ}ᵢₜ˜ [symbol] (μᵢₜ, σᵢₜ), and obtain estimates \hat{x}ᵢₜ=xᵢ₀+\hat{δ}ᵢₜ, ∀t∈{1 . . . T}. FIG. 15 illustrates this estimation using the same data to generate the distributions of FIG. 14. More specifically, FIG. 15 discloses estimating \hat{x}ᵢₜ=\hat{x}ᵢ₀+\hat{δ}ᵢₜ, ∀t with a model [symbol] (xᵢ₀, t)= [symbol] (μᵢₜ, σᵢₜ) derived from the data shown in FIG. 8. Despite some errors introduced with the estimation, this demonstrates the feasibility of generating models for diffusion processes using real data.

In more detail, FIG. 15, which includes subfigures 1502, 1504, 1506, and 1508, discloses a comparison of the original diffusion process with 40 steps aggregated with an exponential decay schedule and the synthetized one with all \hat{x}ᵢₜ, for the full d=32 dimensions of the quantum state vectors. Like any modelling approach, estimating \hat{x}ᵢₜ from \hat{δ}ᵢₜ˜ [symbol] (μᵢₜ, σᵢₜ) may introduce errors relative to the ground truth xᵢₜ. As can be seen in the subfigure 1506 of FIG. 15, the synthetic diffusion process makes transitions between diffusion steps less smooth, especially at the initial steps of the evolution. In subfigure 1508, the distribution of estimation errors and how they get larger for higher values of t, can be seen. In this example, 75% of the estimation errors were below 0.013.

The examples of FIGS. 14 and 15, thus illustrate the feasibility, in an embodiment, of generating such a model for a diffusion process, from real data. As a result, the whole diffusion data may be discarded once [symbol] has been built.

### D.3.2 Data Sampler (Non-Parametric)

This method, according to one embodiment, may follow the same principles of estimating diffusion process steps directly from data, but it applies to cases in which the data represent discrete probability distributions. In particular, this example method has been devised to address a particular use case, namely, the evolution of quantum state probabilities.

Advantageously, this example sampling method, as compared with a sampling method involving a parametric data model, is that an embodiment may keep only the final step of the diffusion process, referred to as x₀ in various embodiments. As x₀, in this case, is a probability distribution itself, an embodiment may assume that x₀= [symbol] , and use it to sample \hat{x}ₜ directly. As in the previous modelling approach, an embodiment may combine the proposed method with any window scheduling approach.

For example, consider an exponential decay window schedule with T=40 steps. As before, x₀ is the discrete probability distribution equivalent to the clean data step of the diffusion process. Assume that the window sizes of the schedule are {w₁, w₂, . . . , w_{T}}. An example embodiment of a sampling method works as follows:

| | |
|---|---|
| 1. | For each t E {1, ... , T} |
| | $a . M = {\sum }_{k = 1}^{t} {w}_{k}$ |
| | b. cₜ = 0 is an array the size of x₀ |
| | c. For j E {1, ... , M} |
| | i. k~P(x₀) is a sampled element of x₀, with replacement |
| | ii. cₜₖ = cₜₖ + 1 to increase by one the count of the sampled |
| | element |
| | d. \hat{x}ₜ = cₜ/Σcₜ |

This procedure thus samples from P(x₀) as many times as the accumulated sum of the window sizes up to step t and updates the counts of the elements in cₜ accordingly. An estimate for the probability distribution at step t, \hat{x}ₜ, is finally obtained by normalizing the counts obtained through the sequence of sampling operations.

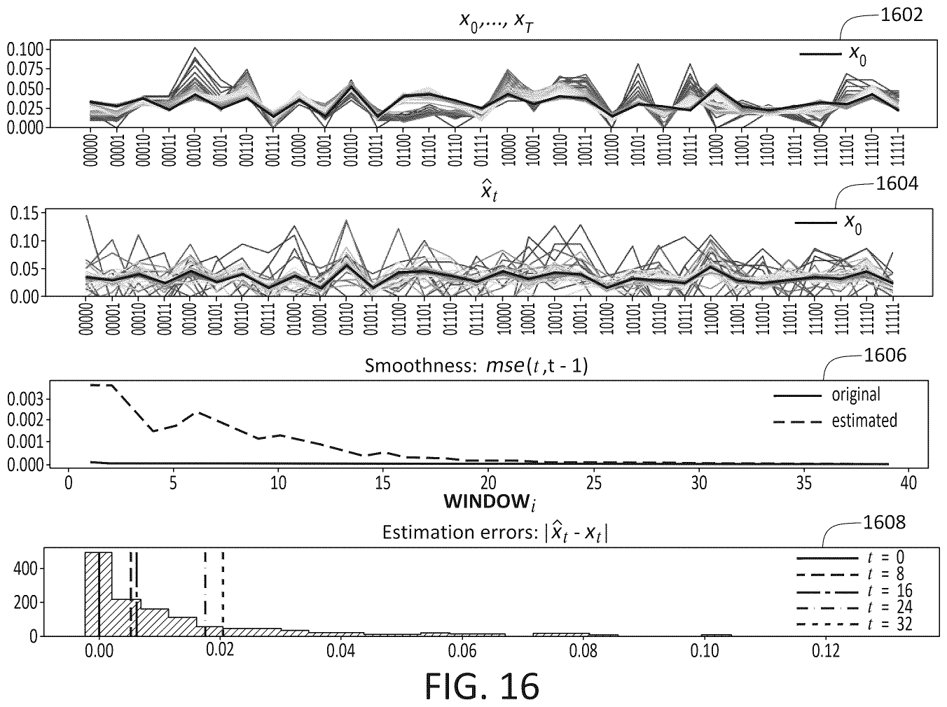

FIG. 16 shows some example results of applying the sampling method with the same data sample of FIG. 15. Particularly, FIG. 16, which includes subfigures 1602, 1604, 1606, and 1608, discloses obtaining estimates for the probability distributions \hat{x}ₜ by sampling directly from x₀, when the latter represents a discrete probability distribution. The sampling is combined with a window scheduling approach that controls the number of sampling operations for time step. It can be observed from FIG. 16 that using just x, as the source for estimating \hat{x}ₜ may introduce more errors than the parametric data sampling approach. In this example, the smoothness, shown in subfigure 1606, was a bit worse than with the parametric data sampling approach, and the 75% of the estimation errors were below 0.051, as opposed to 0.013 in the approach disclosed in FIG. 15. Nonetheless, the non-parametric data sampling approach may still be a valid approach when the diffusion process data are discrete probability distributions, which is the case in the example use case of quantum computing.

### D.4 DM Training and Sampling Revisited

### D.4.1 Modelling Reverse Diffusion Steps Directly

One way of training a DM is to make the model learn to predict step xₜ₋₁ directly from step xₜ. In [8], this is done assuming Markovian principles and forcing Gaussian assumptions. Namely, the diffusion process is modelled as a probability distribution P(xₜ₋₁|xₜ)= [symbol] (xₜ₋₁; μ(xₜ, t), Σ(xₜ, t)). While one example embodiment may keep the Markovian principle, that embodiment may depart from Gaussian assumptions by considering that the diffusion process will be supported by the availability of data collected directly from the diffusion steps, that is, real data.

In a basic form, a conventional DM is trained to minimize the difference between true samples, xₜ, and their estimated counterparts, \hat{x}ₜ, across a training dataset. One example embodiment may do this by employing one of the disclosed window scheduling methods. Namely, an embodiment may define a loss function [symbol] (xₜ, \hat{x}ₜ)=divergence(xₜ, M_{θ}(xₜ₊₁), which measures the referred difference. The derivative of [symbol] with respect to θ is used to update the parameters θ of the model. A difference with respect to the conventional DM here is that, in an embodiment, xₜ₊₁ comes directly from the real data aggregated at window t+1, instead of being a synthetic, pre-computed sample using a pre-determined (Gaussian) degradation function.

In an embodiment, when sampling, the trained DM may be initially fed with some random xₜ, t=T, to generate \hat{x}ₜ₋₁. Recursively, \hat{x}ₜ₋₁ is used to generate \hat{x}ₜ₋₂ and so on until an estimate of clean data is obtained at x₀.

### D.4.2 Modelling Degradations

In [9], it was demonstrated that better image quality could be obtained at \hat{x}₀ if the DM were trained to predict the amount of noise added to x₀ to generate xₜ. Modelling added noise has since become the mainstream approach of using DMs in all applications.

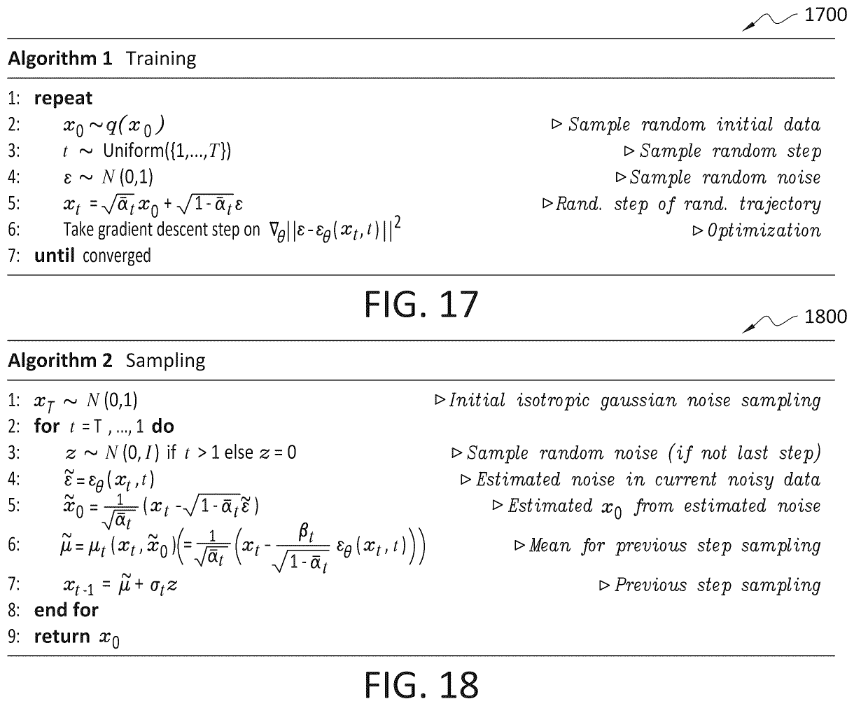

FIG. 17 discloses a baseline algorithm 1700 that may be used to train a conventional DM (see [7]) to learn the added noise. In line 5 of the algorithm 1700, a noisy sample xₜ is computed by combining a random clean data sample x₀ (line 2) with random Gaussian noise ϵ (line 4). The noisy sample is generated according to the pre-defined noisy schedule at, which determines the mix of x₀ and ϵ.

One example embodiment comprises a modification of steps 4 and 5 of the algorithm 1700 to incorporate the disclosed methods and leverage the modelling approaches disclosed herein, combined with the window scheduling approaches disclosed herein. As well, step 6 of the algorithm 1700 is modified in an embodiment since one embodiment is directly modeling the relation between xₜ and x₀ using M_{θ}(⋅), rather than modeling the noise ϵ(⋅).

Consider a model M_{Φ}(x₀, t) such that \hat{x}ₜ=M_{Φ}(x₀, t) is an estimate of how much x₀ was modified to generate time step t, according to the data used to train M_{Φ}. In one embodiment, lines 4 and 5 of the algorithm 1700 have been modified as follows:

$${\hat{x}}_{t} = {M}_{Φ} ( {x}_{0} , t ) . \qquad 4$$

$$ϵ = {\hat{x}}_{t} - {x}_{0} . \qquad 5$$

Namely, \hat{x}ₜ is obtained directly from the data model, and ϵ is defined as the difference between x₀ and \hat{x}ₜ. The DM, in this case, will learn how much x₀ has been modified to generate xₜ.

FIG. 18 discloses a baseline algorithm 1800 to sample from in a conventional DM. Thus, the algorithm 1800 starts from pure noise, at step T, and iteratively denoises the data to generate xₜ₋₁. At each iteration, the noise, \tilde{ϵ}, used to generate xₜ is estimated from the trained DM, as indicated in line 4 of the algorithm 1800. From there, an estimate \tilde{x}₀ is obtained by removing the estimated noise from xₜ, using the pre-defined schedule α̅ₜ, in line 5. Given the Gaussian assumptions of the conventional DM, line 6 is used to compute the mean of the denoised image xₜ₋₁. Such mean is combined with the expected noise variance for step t, according to the pre-defined scheduling function, in line 7 of the algorithm 1800.

By way of contrast, and using the methods disclosed herein, the sampling process can become much simpler. Thus, an algorithm according to one embodiment is as follows:

| | |
|---|---|
| 1. | x_{t′} = snapshot (t′) |
| 2. | for t = t′, ...,1 do |
| 3. | \tilde{ϵ} = ϵ_{θ}(xₜ, t) |
| 4. | \hat{x}₀ = xₜ − \tilde{ϵ} |
| 5. | \hat{x}ₜ₋₁ = M_{Φ}(\tilde{x}₀, t − 1) |
| 6. | end for |
| 7. | return \hat{x}₀ |

That is, this algorithm starts with a snapshot of the evolution at time step t′. Then, the model iteratively estimates the amount of degradation, \tilde{ϵ}, applied to generate to xₜ. From there, an estimate of the clean data, \hat{x}₀, is obtained by reverting the degradation. The clean data is finally used to obtain a synthesized data sample at step t−1 using the scheduled data model M_{Φ}. From this synthesized data sample, the whole iteration starts again.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

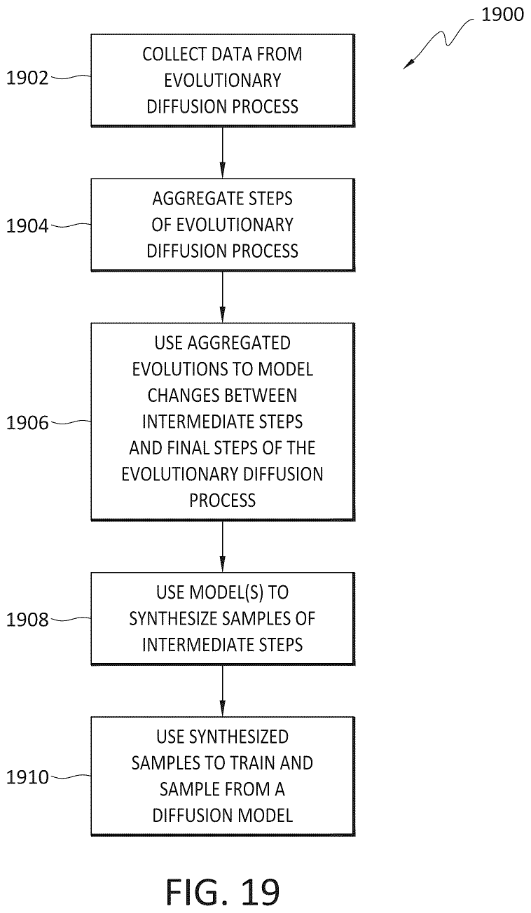

Directing attention now to FIG. 19, there is disclosed an example method 1900 according to one embodiment. Initially, data may be collected 1902 from an evolutionary diffusion process. As disclosed herein, one non-limiting example of an evolutionary diffusion process comprises repeated execution of a quantum algorithm. The data that is collected 1902 thus comprises real data from a real world process, and is not synthesized data.

The collected 1902 data may then be used in and/or to define an aggregation 1904 of the steps, or evolutions of the data, of the evolutionary diffusion process. Various methods, according to certain embodiments, are disclosed herein for this aggregation 1904 process.

The aggregated 1904 evolutions may then be used to model 1906 changes between the intermediate steps, and the final step, of the evolutionary diffusion process. Various models may then be used to synthesize 1908 samples of intermediate steps of the evolutionary diffusion process. It is noted there that a synthesized sample does not include synthesized data. Rather, it is the bounds that define the extent of the sample that are synthesized. As explained herein, the scope of a sample may vary.

Finally, the synthesized samples may be used 1910 to train, and sample from, a diffusion model. As noted herein, the scope of this disclosure and the claims is not limited to a diffusion model involving quantum operations. Rather, a diffusion model according to one embodiment may be employed in any application where a dataset may be subject to forward, and/or reverse, diffusion.

### F. Further Example Embodiments

Following are some further example embodiments. These are presented only by way of example and are not intended to limit the scope of this disclosure or the claims in any way.
Embodiment 1. A method, comprising: collecting data associated with an evolutionary diffusion process; aggregating steps of the evolutionary diffusion process to define windows that each include a respective set of steps; using the steps in the windows to create a model that models changes between intermediate steps of the evolutionary diffusion process, and a final step of the evolutionary diffusion process; using the model to synthesize data samples associated with the intermediate steps; and using the synthesized data samples to train the model.
Embodiment 2. The method as recited in any preceding embodiment, wherein the evolutionary diffusion process comprises a process in which the data progressively degrades, or improves, at each of the steps of the evolutionary diffusion process.
Embodiment 3. The method as recited in any preceding embodiment, wherein the data comprises real, rather than synthesized, data.
Embodiment 4. The method as recited in any preceding embodiment, wherein degradations in the data occur as a natural part of the evolutionary diffusion process, and the degradations are not synthesized.
Embodiment 5. The method as recited in any preceding embodiment, wherein the model comprises a diffusion model operable to increase, and decrease, degradation of input data provided to the model.
Embodiment 6. The method as recited in any preceding embodiment, wherein the model is also trained using one or more features, and outputs of one or more data models.
Embodiment 7. The method as recited in embodiment 6, wherein the one or more data models comprise a parametric data model, and/or a non-parametric data model.
Embodiment 8. The method as recited in any preceding embodiment, wherein a schedule is used to determine respective sizes of the windows.
Embodiment 9. The method as recited in embodiment 8, where the schedule comprises one of: a constant window schedule; or a window decay schedule that comprises either an exponential window decay schedule or a linear window decay schedule.
Embodiment 10. The method as recited in any preceding embodiment, wherein sizes of the windows are based on a balancing of a relative smoothness between window transitions, and keeping a number of initial steps of the evolutionary diffusion process as low as possible.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

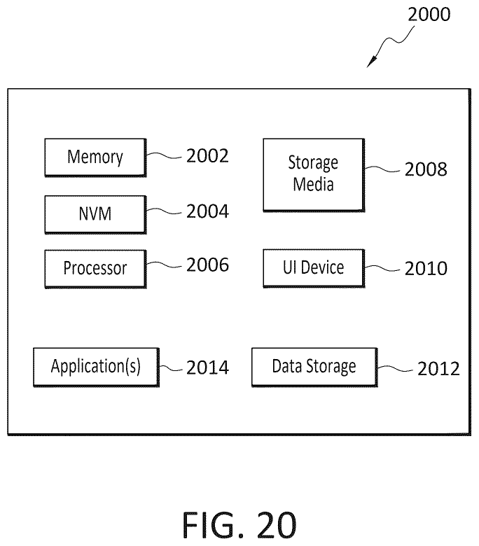

With reference briefly now to FIG. 20, any one or more of the entities disclosed, or implied, by FIGS. 1-19, and/or elsewhere herein, may take the form of, or include, or be implemented on, or hosted by, a physical computing device, one example of which is denoted at 2000. As well, where any of the aforementioned elements comprise or consist of a virtual machine (VM), that VM may constitute a virtualization of any combination of the physical components disclosed in FIG. 20.

In the example of FIG. 20, the physical computing device 2000 includes a memory 2002 which may include one, some, or all, of random access memory (RAM), non-volatile memory (NVM) 2004 such as NVRAM for example, read-only memory (ROM), and persistent memory, one or more hardware processors 2006, non-transitory storage media 2008, UI device 2010, and data storage 2012. One or more of the memory components 2002 of the physical computing device 2000 may take the form of solid state device (SSD) storage. As well, one or more applications 2014 may be provided that comprise instructions executable by one or more hardware processors 2006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
collecting data associated with an evolutionary diffusion process;
aggregating steps of the evolutionary diffusion process to define windows that each include a respective set of steps;
using the steps in the windows to create a model that models changes between intermediate steps of the evolutionary diffusion process, and a final step of the evolutionary diffusion process;
using the model to synthesize data samples associated with the intermediate steps; and
using the synthesized data samples to train the model.

2. The method as recited in claim 1, wherein the evolutionary diffusion process comprises a process in which the data progressively degrades, or improves, at each of the steps of the evolutionary diffusion process.

3. The method as recited in claim 1, wherein the data comprises real, rather than synthesized, data.

4. The method as recited in claim 1, wherein degradations in the data occur as a natural part of the evolutionary diffusion process, and the degradations are not synthesized.

5. The method as recited in claim 1, wherein the model comprises a diffusion model operable to increase, and decrease, degradation of input data provided to the model.

6. The method as recited in claim 1, wherein the model is also trained using one or more features, and outputs of one or more data models.

7. The method as recited in claim 6, wherein the one or more data models comprise a parametric data model, and/or a non-parametric data model.

8. The method as recited in claim 1, wherein a schedule is used to determine respective sizes of the windows.

9. The method as recited in claim 8, where the schedule comprises one of: a constant window schedule; or a window decay schedule that comprises either an exponential window decay schedule or a linear window decay schedule.

10. The method as recited in claim 1, wherein sizes of the windows are based on a balancing of a relative smoothness between window transitions, and keeping a number of initial steps of the evolutionary diffusion process as low as possible.

11. A non-transitory storage medium having stored therein instructions that are executable by one or more hardware processors to perform operations comprising:
collecting data associated with an evolutionary diffusion process;
aggregating steps of the evolutionary diffusion process to define windows that each include a respective set of steps;
using the steps in the windows to create a model that models changes between intermediate steps of the evolutionary diffusion process, and a final step of the evolutionary diffusion process;
using the model to synthesize data samples associated with the intermediate steps; and
using the synthesized data samples to train the model.

12. The non-transitory storage medium as recited in claim 11, wherein the evolutionary diffusion process comprises a process in which the data progressively degrades, or improves, at each of the steps of the evolutionary diffusion process.

13. The non-transitory storage medium as recited in claim 11, wherein the data comprises real, rather than synthesized, data.

14. The non-transitory storage medium as recited in claim 11, wherein degradations in the data occur as a natural part of the evolutionary diffusion process, and the degradations are not synthesized.

15. The non-transitory storage medium as recited in claim 11, wherein the model comprises a diffusion model operable to increase, and decrease, degradation of input data provided to the model.

16. The non-transitory storage medium as recited in claim 11, wherein the model is also trained using one or more features, and outputs of one or more data models.

17. The non-transitory storage medium as recited in claim 16, wherein the one or more data models comprise a parametric data model, and/or a non-parametric data model.

18. The non-transitory storage medium as recited in claim 11, wherein a schedule is used to determine respective sizes of the windows.

19. The non-transitory storage medium as recited in claim 18, where the schedule comprises one of: a constant window schedule; or a window decay schedule that comprises either an exponential window decay schedule or a linear window decay schedule.

20. The non-transitory storage medium as recited in claim 11, wherein sizes of the windows are based on a balancing of a relative smoothness between window transitions, and keeping a number of initial steps of the evolutionary diffusion process as low as possible.
